(19) United States
(12) Patent Application Publication
(10) Pub. No.: US 2009/0249636 A1
(43) Pub. Date: Oct. 8, 2009

(54) Cutting tape measure apparatus

(75) Inventors: Ronald Reda, Chicago, IL (US); Imtiaz Musaliar, Chicago, IL (US)

Correspondence Address: SEYFARTH SHAW LLP, 131 S. DEARBORN ST., SUITE 2400, CHICAGO, IL, 60603-5803, US

(73) Assignee: Draupnir, LLC

(21) Appl. No.: 12/080,658

(22) Filed: Apr. 3, 2008

(51) Int. Cl. G01B 3/10

(52) U.S. Cl. 33/760

(57) ABSTRACT

A precision measurement and cutting tool for cutting a material, the precision measurement and cutting tool comprising: a measurement tape, a housing for containing a measurement tape having an opening for the measurement tape on a first side, and a first cartridge mounted at an end of the measurement tape and containing a retractable first cutting blade. In another embodiment, a precision measurement and cutting tool for cutting a material, the precision measurement and cutting tool comprising: a measurement tape having a top side and a bottom side and measuring indicia on the top side, a housing for containing a measurement tape having a first side opposite a second side and a top side opposite a bottom side and having an opening for the measurement tape on a first side that is opposite a second side, a first cartridge mounted at an end of the measurement tape and containing a retractable first cutting blade and including a bias member for biasing the cartridge to a position wherein the first cutting blade is covered and retracted, an engagement portion on the first cartridge mechanically coupled to the retractable first cutting blade such that moving the engagement portion moves the retractable cutting blade to one of a retracted and an un-retracted position.

### BACKGROUND OF THE INVENTION

Tape measure tools with cutting capabilities can be used to crop or cut a variety of materials, including both synthetic and organic building materials, according to precise specifications. Often, in such cutting tools, there is a compromise between precision of the cut and safety and ease of use of the device. The device of the present invention can incorporate multiple functionalities for cutting drywall or various other building materials. Multiple interacting blades and safety mechanisms, along with measuring components, allow the device to cut building materials or other materials precisely, quickly and efficiently.

There is a need for a device that allows workers to measure and cut building materials simultaneously and with a single tool. For example, measuring and cutting a piece of drywall would be much more efficient and precise if the worker can avoid using separate measuring, marking and cutting tools in the process. Switching between such tools may introduce measurement, marking or cutting errors that can waste time and resources. In order to overcome these and other problems, it would be more efficient for the worker to have an single tool that accomplishes all of these functions at substantially the same time.

A cutting wheel attached to the end of a measuring tape is known. However, the cutting wheel is not itself sliceable or moveable in order to facilitate ease of use. Other tape measures are known with a handle for cutting straight lines, but fail to disclose a cutting wheel or retractable cartridge. Still other prior art discloses a knife blade extending from the end of the tape from a sleeve with a fastener, or a pivoting nail attached to the tape and a cutting blade to the tape measure housing. Yet, both of these disclosures fail to claim or teach the use of a slideable/movable cartridge at the end of the tape of a tape measure for cutting or marking a surface.

### SUMMARY OF THE INVENTION

An object of embodiments of the invention is to provide a precision measurement and cutting system for cutting a material.

Another object of embodiments of the invention is to provide a precision measurement and cutting system for cutting a material that also has enhances safety features.

Yet another object of embodiments of the invention is to provide a precision measurement and cutting system for cutting a material that has two sets of retractable blades.

Additional features and advantages of embodiments of the invention will be set forth in the description which follows, and in part will be apparent from the description, or may be learned by practice of embodiments of the invention. The objectives and other advantages of the embodiments of the invention will be realized and attained by the structure particularly pointed out in the written description and claims hereof as well as the appended drawings.

To achieve these and other advantages and in accordance with the purpose of embodiments of the invention, as embodied and broadly described, the precision measurement and cutting system for cutting a material includes: a precision measurement and cutting tool for cutting a material, the precision measurement and cutting tool comprising: a measurement tape, a housing for containing a measurement tape having an opening for the measurement tape on a first side, and a first cartridge mounted at an end of the measurement tape and containing a retractable first cutting blade.

In another aspect, the precision measurement and cutting system for cutting a material includes: a precision measurement and cutting tool for cutting a material, the precision measurement and cutting tool comprising: a measurement tape having a top side and a bottom side and measuring indicia on the top side, a housing for containing a measurement tape having a first side opposite a second side and a top side opposite a bottom side and having an opening for the measurement tape on a first side that is opposite a second side, a first cartridge mounted at an end of the measurement tape and containing a retractable first cutting blade and including a bias member for biasing the cartridge to a position wherein the first cutting blade is covered and retracted, an engagement portion on the first cartridge mechanically coupled to the retractable first cutting blade such that moving the engagement portion moves the retractable cutting blade to one of a retracted and an un-retracted position.

In yet another aspect, the precision measurement and cutting system for cutting a material includes: a precision measurement and cutting tool for cutting a material, the precision measurement and cutting tool comprising: a measurement tape having a top side and a bottom side and measuring indicia on the top side, a tape hook at a first end of the measuring tape, a housing for containing a measurement tape having a first side opposite a second side and a top side opposite a bottom side and having an opening for the second end of the measurement tape on a first side that is opposite a second side, a first cartridge mounted at an end of the measurement tape and containing a retractable first cutting blade and including a bias member for biasing the cartridge to a position wherein the first cutting blade is covered and retracted, the first cartridge comprising a bracket, an engagement portion on the first cartridge mechanically coupled to the retractable first cutting blade such that moving the engagement portion moves the retractable cutting blade to one of a retracted and an un-retracted position.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the invention and are incorporated in and constitute a part of this specification, illustrate embodiments of the invention and together with the description serve to explain the principles of embodiments of the invention.

FIG. 1a is a perspective view of one embodiment of the present invention with the tape and the outer blade cartridge extended from the housing;

FIG. 1b is another perspective view of the embodiment of FIG. 1a with the tape and the outer blade cartridge in contact with the housing;

FIG. 1c is a rear perspective view of the embodiments of FIGS. 1a and 1b showing a storage compartment for blades;

FIG. 2a is a full side view of the embodiments of FIGS. 1a-1c with the tape and the outer blade cartridge extended from the housing;

FIG. 2b is a full side view of the embodiments of FIGS. 1a-1c with the tape and the outer blade cartridge in contact with the housing;

FIG. 2c is a partially exploded perspective view of the embodiments of FIGS. 1a-1c and 2a-2b;

FIG. 3a is a partially exploded perspective view of the outer blade cartridge provided at an end of a tape of a tool of FIGS. 1 and 2;

FIG. 3b is a close-up view of the cutter button and blade of FIG. 3a in retracted mode;

FIG. 3c is a close-up view of the cutter button and blade of FIG. 3a in extended mode;

FIG. 4a is a side view of another embodiment of the present invention including a pivoting pin located on the back of the housing;

FIG. 4b is a plan view of the tool of FIG. 4a illustrating the circular cutting path of the cutting blade relative to the pivot pin;

FIG. 5a is a side view of another embodiment of the present invention including a secondary cutting blade located in the back of the housing;

FIG. 5b is a partial side view of the tool of FIG. 5a, oriented so that the secondary cutting blade may be used to mark or cut a surface;

FIG. 6 is a perspective view of another embodiment of the present invention, including a laser tip attached to a modified bracket;

FIG. 7a is a side view of a bracket having a pivotable cover and cutting blade;

FIG. 7b is a perspective view of another bracket of having a pivotable cover and cutting blade;

FIG. 8a is a perspective view of another retractable cartridge in a retracted position;

FIG. 8b is an end view of the retractable cartridge of FIG. 8a in an un-retracted position;

FIG. 9 is a perspective view of a pivotable and retractable cartridge; and

FIG. 10 is a perspective, partially exploded view of one embodiment of the tool of the present invention depicting a guide blade holder assembly.

### DETAILED DESCRIPTION OF THE PREFERRED EMBODIMENTS

Reference will now be made in detail to the preferred embodiments of the invention, examples of which are illustrated in the accompanying drawings. It will be apparent to those skilled in the art that various modifications and variations can be made in the embodiments of the invention, the computer assisted process for providing liquidity to an enterprise by utilizing intellectual property assets, without departing from the spirit or scope of the embodiments of the invention. Thus, it is intended that embodiments of the invention cover the modifications and variations of this invention provided within the scope of the appended claims and their equivalents. Like reference numerals in the drawings denote like elements.

As disclosed herein, it should be understood that the term “cutting blade” should be read to incorporate a variety of shaped blades, including but not limited to disk shaped blades, polygonal or trapezoidal shaped blades, and any other shaped blade. It should also be noted, that although the “cartridges” as defined and referenced in this specification are illustrated in connection with cutting blades, in at least one embodiment of the present invention, the cartridges could contain a variety of useful implements apart from blades such as, but not limited to pins, lasers, markers, and other tools associated with the art of tape measures and measuring.

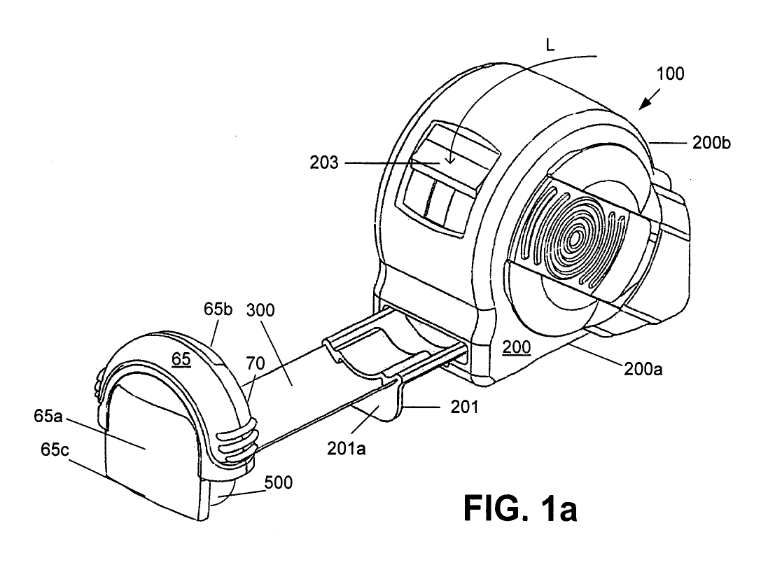

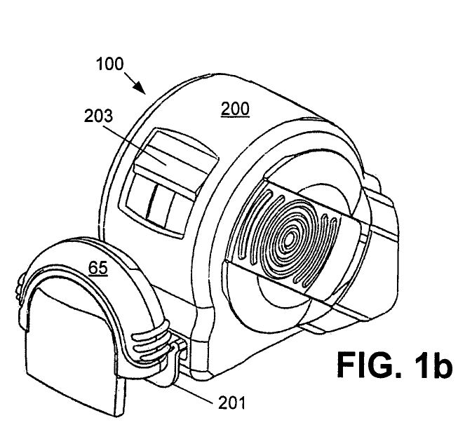

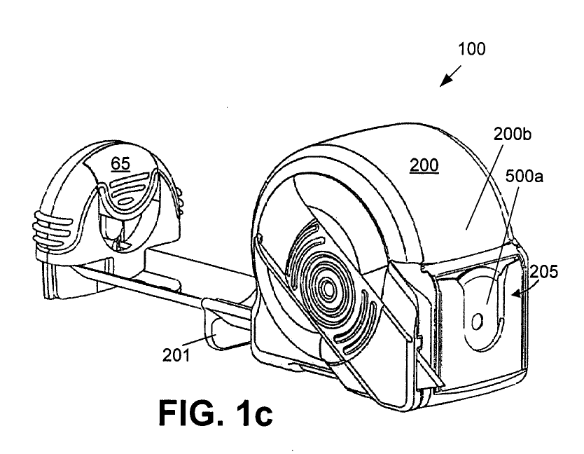

FIG. 1a is a perspective view of one embodiment of the present invention with the tape and the outer blade cartridge extended from the housing. Referring to FIG. 1a, in one embodiment, the tool 100 comprises a housing 200. The tool 100 may comprise a tape measure or other measuring tool known in the art which utilize a housing with a tape with measurement indicia stored inside the housing. Although FIG. 1a shows the housing 200 to have a cylindrical shape, the housing 200 may have one of a number of shapes including square, oval and spherical. The housing 200 can be composed of one or a combination of a number of materials including metal, plastic and wood. Extending from the housing 200 and tethered (not shown) inside the housing 200 is the tape 300. The tape 300 is composed of metalized plastic. Alternatively, the tape 300 can be composed of one of or a combination of a number of materials including metal, plastic and rubber. The tape may have a shape with a cross section composed of arcs, as shown in FIG. 1a, or it can have one of a number of other shapes including those having a semi-circular cross-section, flat rectangular shaped cross section, a D-shaped cross section and an L-shaped cross-section. The tape 300 has measuring indicia (not shown) on at least one side of the tape. The tape 300 can have measuring indicia (not shown) indicative of length, level or other measurement.

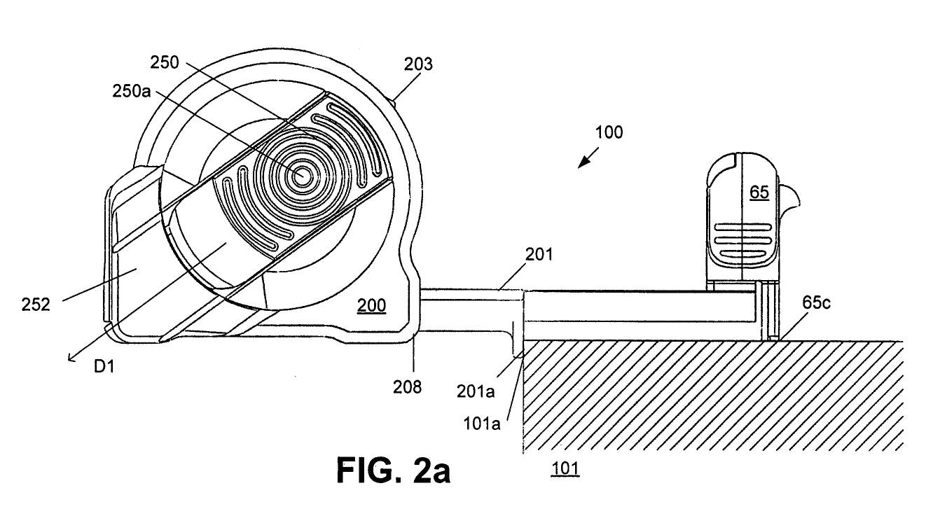

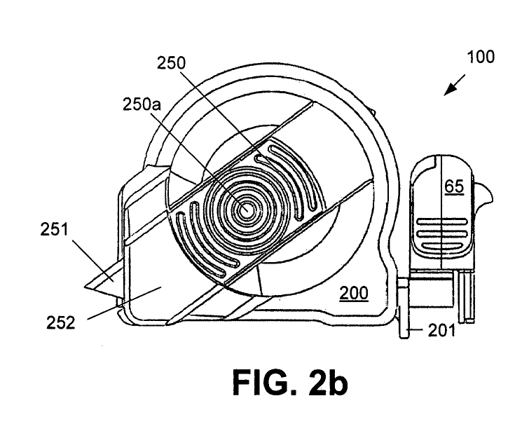

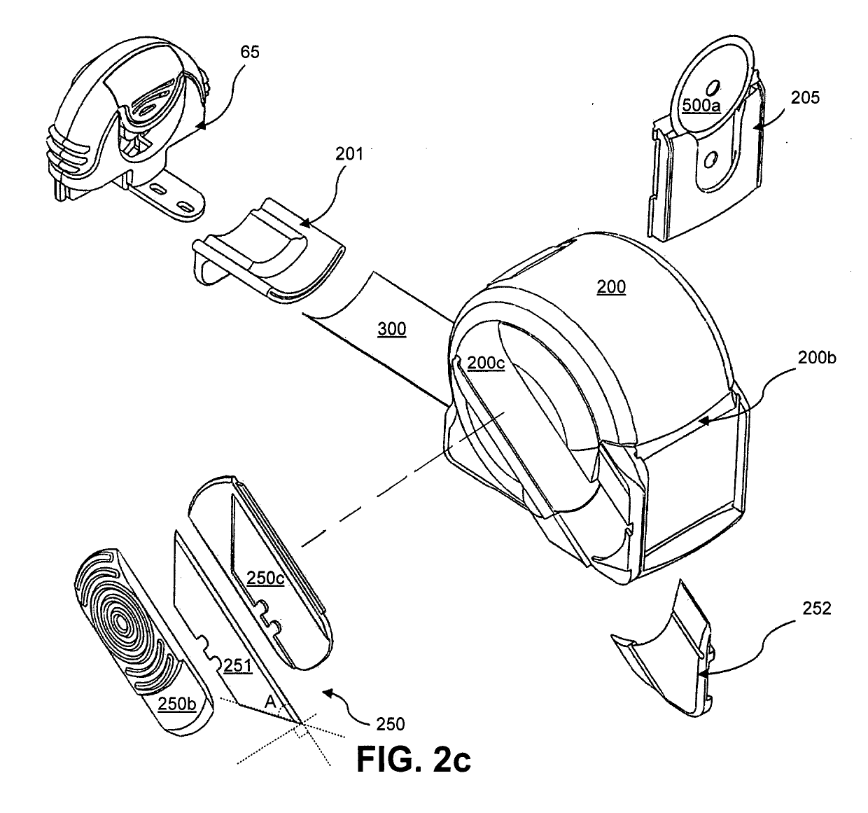

As shown in FIG. 1a, an outer blade cartridge 65 is attached at the tape 300 end distal from the housing 200. The outer blade cartridge 65 may also include a tape hook (not shown). The outer blade cartridge 65 contains an outer cutting blade 500 (FIGS. 1a) which can be used to cut various surfaces. As shown in FIG. 1a, the outer blade cartridge 65 has a guard 65a that shields the user from contact with the blade. Alternatively, the outer blade cartridge 65 can have no such guard 65a. As shown in FIG. 1a, the housing 200 has a finger guard 201 that prevents the users fingers from contacting the tape 300 when it is retracted into the housing 200. The finger guard 201 also allows the user to lock the tape 300 in place when the user presses on the finger guard 201 in the direction of the tape 300. Pressing on the finger guard 201 in the direction of the tape 300 causes the finger guard 201 to pinch the tape 300 and hold it in position. The front face 201a of the finger guard 201 acts as the guide and the datum surface for measuring and cutting operations. This function will be further detailed in FIG. 2.

The finger guard 201 can be tab shaped, as shown in FIG. 1a, or it may have one of a number of other shapes including rectangular, disk shaped or D-shaped. As also shown in FIG. 1a, the housing 200 has a tape release button 203. In FIG. 1a the release button 203 is shown in the released position. In this position, the tape 300 and the outer blade cartridge 65 can be extended from the housing 200 as desired. Placing the release button 203 in the locked position by moving it downward in direction L, as shown in FIG. 2a, locks the tape 300 and the outer blade cartridge 65 cartridge into place and prevents relative movement of the tape 300 and the outer blade cartridge 65 from the housing 200. The release button 203 can be a slide button, as shown in FIG. 1a, or it can be one of a number of other types of buttons including a click button, a latch or a lever.

FIG. 1b is another perspective view of the embodiment of FIG. 1a with the tape and the outer blade cartridge 65 in contact with the housing. As shown in FIG. 1b, outer blade cartridge 65 can simply touch the housing 200. Alternatively, there can be a depression or a mating portion (not shown) of the housing 200 for receiving the outer blade cartridge 65. The depression or a mating portion (not shown) of the housing 200 can be such that the outer blade cartridge 65 fits entirely inside it or the depression or a mating portion (not shown) of the housing 200 can be such that the outer blade cartridge 65 fits partially inside it.

FIG. 1c is a rear perspective view of the embodiments of FIGS. 1a and 1b showing a storage compartment for blades. Typically the storage compartment 205 contains replacement blades 500a for the outer cutting blade 500 (not shown in FIGS. 1a-1c), as shown in FIG. 1c. Alternatively, the storage compartment 205 can contain other replacement blades such as blades mounted to the housing 200. The storage compartment 205 can be mounted on the back 200b of the housing 200, as shown in FIG. 1c, or it can be mounted on another part of the housing.

FIG. 2a is a full side view of the embodiments of FIGS. 1a-1c with the tape and the outer blade cartridge extended from the housing and FIG. 2b is a full side view of the embodiments of FIGS. 1a-1c with the tape and the outer blade cartridge in contact with the housing. As is shown in FIG. 2a and FIG. 2b, the outer blade cartridge 65 and tape 300 can be pushed toward the housing 200 so that it is in contact with the housing, as shown in FIG. 1b, or the outer blade cartridge 65 can be extended from the housing 200, as shown in FIG. 1a. This movement is possible as long as the release button 203 is in the released position (FIG. 1a).

As shown in FIG. 2a, the front face 201a of the finger guard 201 touches the material 101 being cut, thus acting as the guide and the datum surface for measuring and cutting operations. On an embodiment (not shown) without the finger guard 201, the front face of the housing, 208 (FIG. 2a) would act as the guide and the datum.

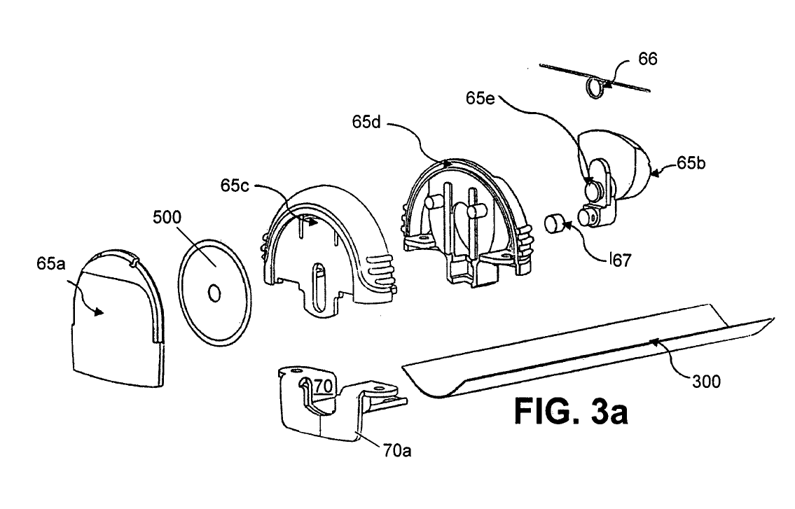

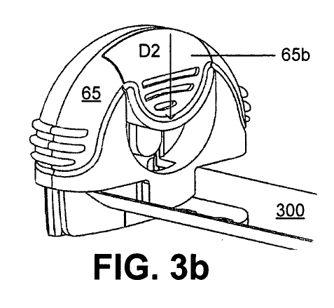

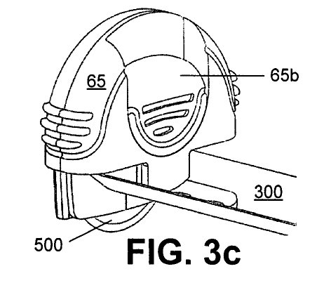

When the outer blade cartridge 65 is in contact with the housing 200 as shown in FIG. 2b, the tape 300 is fully wound and stored entirely within the housing 200. This is the storage mode of the tool 100. When the tool is to be used for cutting a surface, the outer blade cartridge 65 is extended from the housing as shown in FIG. 2a. The tool 100 is then placed on the surface of a material (not shown) such that the guide/datum surface (i.e., the front face 201a of the finger guard or the front surface 208 of the housing 200) touches the edge 101a of the material being cut and the bottom 65c of the outer blade cartridge 5 touches the surface of the material 101. In this manner the tool 100 can be used to cut drywall, plywood, plastic sheeting, metal sheeting, wood, plaster or plastic. Then, the tape 300 is extended to the desired length of the cut according to the measuring indicia (not shown) and locked into place by moving the release button 203 to the locked position by moving it in the direction L (FIG. 1a). The tape 300 can also be locked into position by pinching the finger guard 201. Subsequently, the outer cutting blade 500 (not shown) is engaged and the material (not shown) is cut. The process of blade engagement will be discussed in the context of FIG. 3.

As shown in FIGS. 2b, the finger guard 201 slides into the housing 200 when the outer blade cartridge 65 is in contact with the housing 200. Alternatively, the finger guard 201 can remain outside of the housing 200 when the outer blade cartridge 65 is in contact with the housing 200. Alternatively, a release (not shown) can allow the finger guard 201 to be removed entirely from the tool 100 and stored separately.

As also shown in FIGS. 2a and 2b, the housing has a back cutter assembly 250 that contains a back cutter blade 251. The back cutter assembly 250 contains a finger grip 250a that has an interior contact (not shown) with the back cutter blade 251. Typically, the user contacts the finger grip 250a using one finger, pushes the finger grip in the direction D1 (FIG. 2a) in order to expose part of the back cutter blade 251, as shown in FIG. 2b. The back cutter blade 251 can then be used to cut the surface of a material (not shown). Typically, the back cutter blade 251 is trapezoidally shaped. However, the back cutter blade 251 can have one of a number of other shapes including a rounded shape, a rectangular shape or a triangular shape. The back cutter assembly 250 also contains a back cutter cover 252, as shown in FIGS. 2a and 2b. The back cutter cover 252 can have a slit (not shown) for allowing the back cutter blade 251 to be exposed. Alternatively, the back cutter cover can have no openings in which case the user must remove the back cutter cover 252 from the back cutter assembly 250 in order to expose the back cutter blade 251.

FIG. 2c is a partially exploded perspective view of the embodiments of FIGS. 1a-1c and 2a-2b. As shown in FIG. 2c, the replacement blades 500a for the outer cutting blade 500 are slid directly into the storage compartment 205. The storage compartment 205 is then slid onto the back 200b of the housing 200 where it is fixed by a fastener or snap (not shown). The finger guard 201 slides directly onto the tape 300 and the outer blade cartridge 65 slides directly onto the finger guard 201. As shown in FIG. 2c, the back cutter assembly 250 has two halves, 250b and 250c, that clasp the back cutter blade 251 in order to form the unit shown in FIGS. 2a and 2b. The assembled back cutter assembly 250 is then mounted on the housing 200 by placing it into the groove 200c on the housing 200 and applying a fastener or snap (not shown) or captured in position by the back cutter cover 252. The back cutter cover 252 is then placed on the back cutter assembly 250 in order to shield the blade from contact with the user or other surfaces.

As shown in FIG. 2c, it is advantageous that the back cutter blade 251 has a corner angle, A, of approximately 45°. The corner angle A is preferably between 30° and 90°. A back cutter blade 251 with a corner angle A between 30° and 90° avoids the buildup of backing paper when the back cutter blade 251 is used to cut drywall or other surfaces backed by paper or similar laminar materials.

FIG. 3a is a partially exploded perspective view of the outer blade cartridge provided at an end of a tape of a tool of FIGS. 1 and 2. As shown in FIG. 3a, the outer cutting blade 500 has a rounded shape. Alternatively, outer cutting blade 500 can have any number of other shapes including a trapezoid, rectangle, C-shape or triangle. The outer cutting blade 500 is mounted to the center cutter housing 65c and the button-side cutter housing 65d the of the outer blade cartridge 65 using the blade bearing 67, as shown in FIG. 3a, and the guard 65a is mounted to the center cutter housing 65c. A spring 66 is fixed to the cutter button 65b at the spring mounting point 65e and the cutter button 65b is fixed to the button-side cutter housing 65d. The outer cutting blade 500, the center cutter housing 65c, the button-side cutter housing 65d and the guard 65a are mounted to the bracket 70 that has a tape hook 70a and to the tape 300 to create the assembly shown in FIG. 3b.

FIG. 3b is a close-up view of the cutter button and blade of FIG. 3a in retracted mode and FIG. 3c is a close-up view of the cutter button and blade of FIG. 3a in extended mode. Depressing the cutter button 65b engages the outer cutting blade 500 via the blade bearing 67. Moving the cutter button 65b from the retracted mode shown in FIG. 3b in the direction D2 (FIG. 3b), extends the outer cutting blade 500 as shown in FIG. 3c. Depressing the cutter button 65b is accomplished typically by the user pressing on it with a single finger. Extending the outer cutting blade 500, as shown in FIG. 3c, engages the outer cutting blade 500 to the material (not shown) to be cut.

The spring 66 provides a restoring force to the cutter button 65b and the outer cutting blade 500 that acts to restore the outer cutting blade 500 to the retracted mode shown in FIG. 3b. In other words, the spring 66 acts to slide the outer cutting blade 500 upward with respect to outer blade cartridge 65 when the user releases pressure on the cutter button 65b, thus, preventing unwanted exposure of the outer cutting blade 500 for safety purposes. Alternatively, a lock mechanism (not shown) can be provided to counteract the spring 66 so that the outer cutting blade 500 remains in the extended mode shown in FIG. 3c after the user depresses the cutter button 65b a first time from the retracted mode shown in FIG. 3b. If the user depresses the cutter button 65b a second time, the cutter button 65b will move upward causing the outer cutting blade 500 to retract as in FIG. 3b. In one embodiment of the present invention, the outer blade cartridge 65 could be replaced on cutter button 65b with a pin, laser, marking implement, or other useful tool.

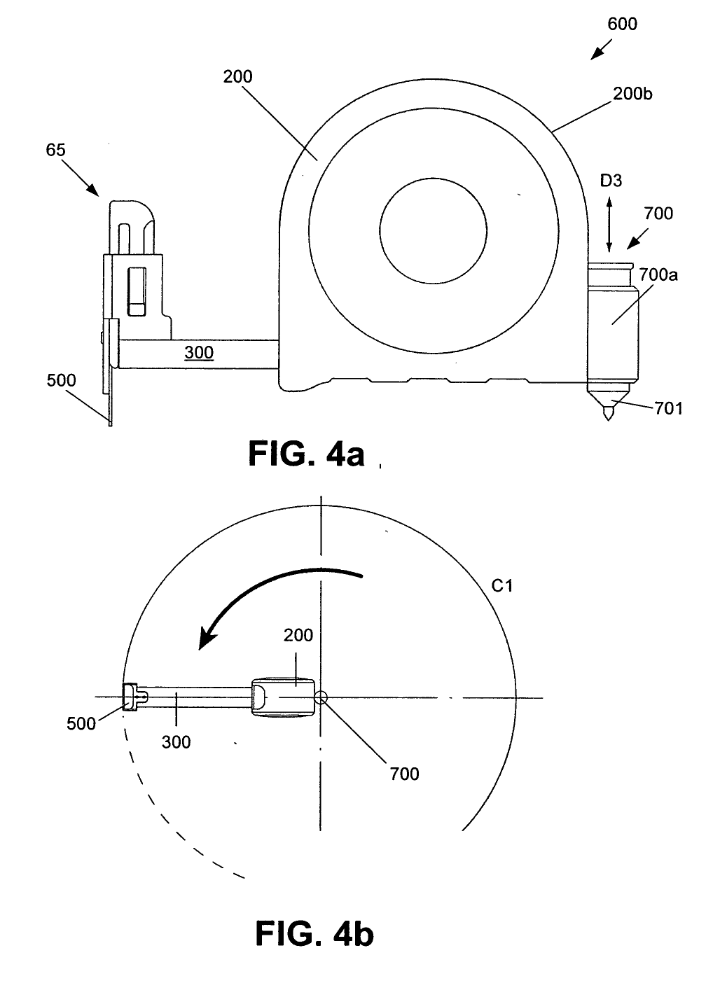

FIG. 4a is a side view of another embodiment of the present invention including a pivoting pin located on the back of the housing. The tool 600 of FIG. 4a has a pivot pin mechanism 700 on the back 200b of the housing 200 has attached on to the end distal from the tape 300 contains a spring loaded pivot pin 701 that moves in the vertical direction D3. The spring (not shown) is in the interior of the casing 700a of the pivot pin mechanism 700. The spring (not shown) provides a restoring force to the pivot pin 701 in order to fix it in a pre-determined position (not shown). Alternatively, the pivot pin mechanism 700 can lack a spring and instead be comprised of a solid pivot pin, a geared pivot pin, or other pivot pin. The pivot pin 701 engages the surface of the material (not shown) to be cut or cropped by the tool 600 allowing for the housing 200 to rotate substantially about pivot pin 701 as shown in FIG. 4b.

FIG. 4b is a plan view of the tool 600 of FIG. 4a illustrating the circular cutting path C1 of the cutting blade relative to the pivot pin. As the housing 200 rotates a full three hundred sixty degrees about the pivot pin 701, the outer cutting blade 500 cuts a substantially circular pattern along the circular cutting path C1 in the material below the outer cutting blade 500. Rotating the housing 200 less than three hundred sixty degrees about the pivot point 701 causes the outer cutting blade 500 to cut an arc along circular cutting path C1 that is less than a full circle. Both the tape 300 and the outer cutting blade 500 rotate relative to the pivot pin 701. In another embodiment of the present invention (not shown), the outer cutting blade 500 is replaced with a marking device (not shown) which allows the tool to be rotated about the pivot point 701 to draw arcs or circles on a surface.

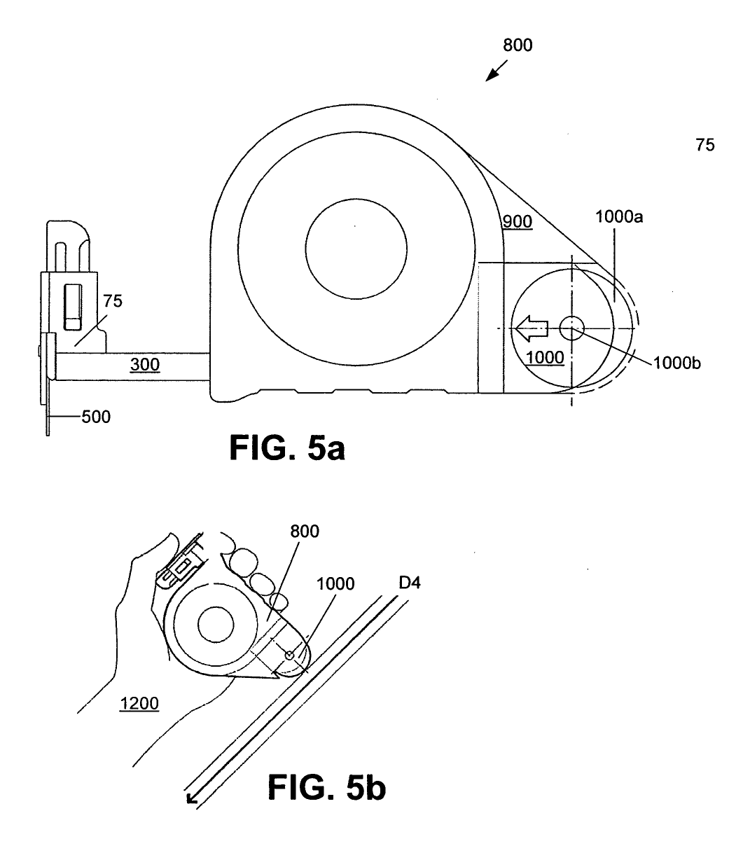

FIG. 5a is a side view of another embodiment of the present invention including a secondary cutting blade located in the back of the housing. The tool 800 of FIG. 5a has a slightly modified housing 900 over the tool 100 of FIG. 1a in that the housing 900 accommodates a secondary cutting blade 1000. The secondary cutting blade 1000 is in communication with a retractable cover 1000a, as shown in FIG. 5a. The retractable cover 1000a can be retracted (not shown) so as to expose the secondary cutting blade 1000 and allow cutting of the surface of a material (not shown) with the secondary cutting blade 1000. The retractable cover 1000a can also be extended, as shown in FIG. 5a, so as to shield the secondary cutting blade 1000 to both protect the user from the secondary cutting blade 1000 and to protect the secondary cutting blade 1000 from inadvertent damage. The retractable cover 1000a can rotate about a central axis pin 1000b, as shown in FIG. 5a, in communication with the housing 900. The secondary cutting blade 1000 can also pivot about a pivot point exterior to the housing (not shown) or slide to a retracted position (not shown). As shown in FIG. 5a, the secondary cutting blade 1000 has a substantially circular shape. Alternatively, the secondary cutting blade 1000 can be trapezoidal, rectangularly shaped or have one of a number of other shapes.

FIG. 5b is a partial side view of the tool 800 of FIG. 5a, oriented so that the secondary cutting blade 1000 may be used to mark or cut a surface 101. The tool 800 is held such that the secondary cutting blade I 000 is engaged and cuts the surface 101. As shown in FIG. 5b, the cutting direction D4 can be a straight line. Alternatively, cuts of any shape or design may be made with the tool 800. As shown in FIG. 5b, the tool 800 is held so the secondary cutting blade 1000 faces away from the user's wrist 1200. Alternatively, the tool 800 can be held in one of a number of positions, including a position (not shown) in which the secondary cutting blade 1000 is closer to the user's wrist 1200 for cutting and removing paper backing from drywall after the gypsum has been cut by the outer cutting blade 500 (FIG. 5a).

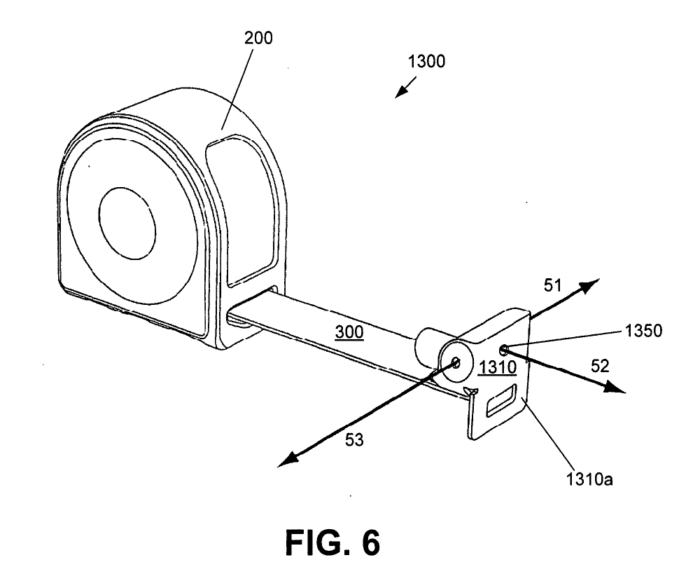

FIG. 6 is a perspective view of another embodiment of the present invention, including a laser tip attached to a modified bracket. The tool 1300 of FIG. 6 has a laser tip 1310 that is mounted onto a modified bracket 1350 for assisting in alignment of the tool 1300. This improves the accuracy of the measurements made by the tool 1300. As shown in FIG. 6, the laser tip 1310 includes a housing 1310a that can act as a hook for fastening the tape 300 to an object to be measured (not shown). The laser tip 1310 can simultaneously generate one or a plurality of reference laser beams 51, 52, or 53, as shown in FIG. 6, that provide substantially parallel or perpendicular references or references at varying angles for alignment of the tape 300 during a measurement. Although FIG. 6 shows three different reference laser beams 51, 52, and 53, additional combinations and/or laser beams can be incorporated into the laser tip 1310.

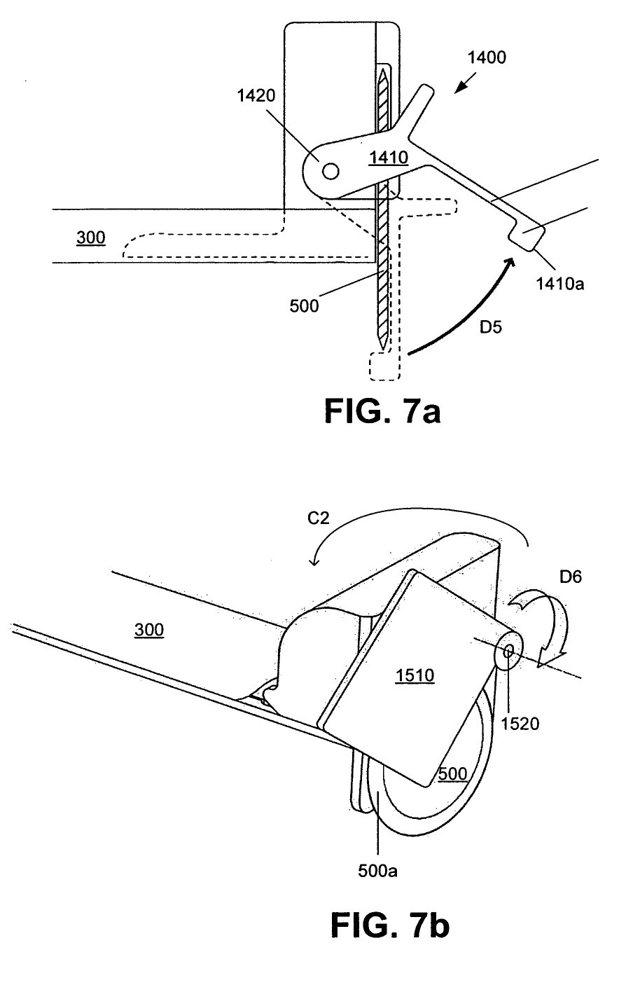

FIG. 7a is a side view of a bracket having a pivotable cover and cutting blade. As shown in FIG. 7a, the pivotable covered bracket 1400 has a pivotable cover 1410 is attached to a hinge 1420 that is mounted perpendicular to the longitudinal axis T of tape 300 to allow the pivotable cover 1410 to rotate in the direction D5, thereby exposing the outer cutting blade 500 for use. FIG. 7a shows that the outer cutting blade 500 is disk shaped. Alternatively, the outer cutting blade 500 can have one of a number of other shapes including trapezoidal and rectangular. The shape of pivotable cover 1410 is such that it completely overlaps the outer cutting blade 500. As seen in FIG. 7a, the shape of the pivotable cover 1410 is rectangular. Alternatively, the pivotable cover 1410 can have one of a number of other shapes including disk shape, trapezoidal shape or a D-shape. As shown in FIG. 7a, the pivotable cover 1410 can have a ridge 1410a that fits snugly over the outer cutting blade 500 in order to protect the user and to protect the outer cutting blade 500 from damage. The ridge 1401 a of the pivotable cover 1410 can completely cover the edge 500a of the outer cutting blade 500, or it can partially cover the edge 500a of the outer cutting blade 500 as shown in FIG. 7a.

FIG. 7b is a perspective view of another bracket having a pivotable cover and cutting blade. As illustrated, the side hinge pivotable covered bracket 1500 has a side hinge pivotable cover 1510 attached to a side hinge 1520. As shown in FIG. 7b, the side hinge 1520 is mounted parallel to the longitudinal axis T of tape 300 to allow the side hinge pivotable cover l 150 to rotate in the direction D6, thereby exposing the outer cutting blade 500 for use. FIG. 7b shows that the outer cutting blade 500 is disk shaped. Alternatively, the outer cutting blade 500 can have one of a number of other shapes including trapezoidal and rectangular. The shape of the side hinge pivotable cover 1510 is such that it completely overlaps the outer cutting blade 500. As seen in FIG. 7b, the shape of the side hinge pivotable cover 1510 is rectangular. Alternatively, the side hinge pivotable cover 1510 can have one of a number of other shapes including disk shape, trapezoidal shape or a D-shape. The side hinge pivotable cover 1510 can have a ridge (not shown) that fits snugly over the outer cutting blade 500 in order to protect the user and to protect the outer cutting blade 500 from damage. The ridge (not shown) of the side hinge pivotable cover 1510 can completely cover the edge 500a of the outer cutting blade 500, or it can partially cover the edge 500a of the outer cutting blade 500.

The side hinge pivotable cover 1510 is attached to the side hinge 1520 in such a manner as to allow the side hinge pivotable cover 1510 to rotate up to three hundred sixty degrees about circular path D6 relative to the side hinge 1520 and parallel to the edge 500a of the outer cutting blade 500. Motion of the side hinge pivotable cover 1510 along the circular path D6 alternatively exposes or covers the outer cutting blade 500.

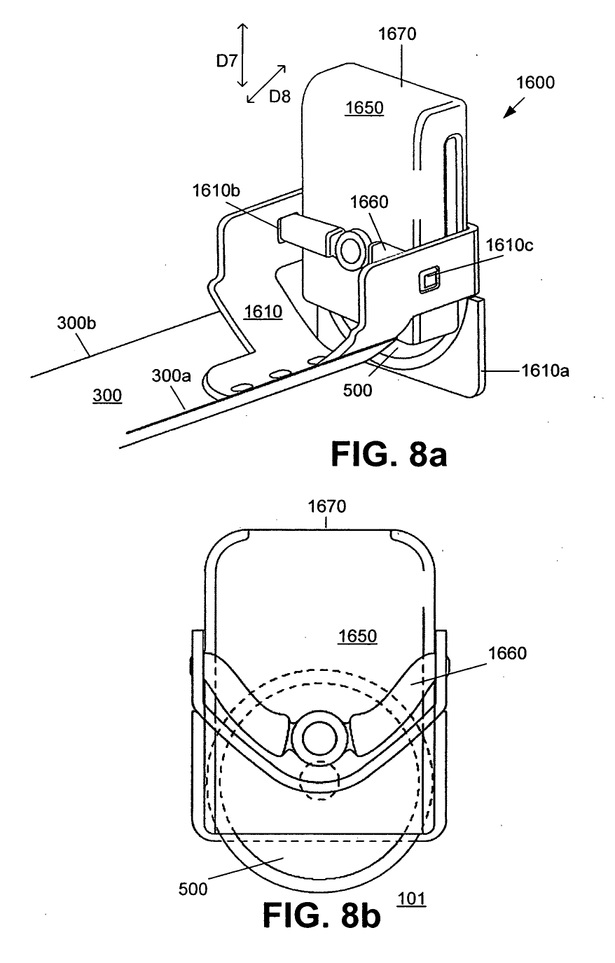

FIG. 8a is a perspective view of another retractable cartridge in a retracted position. As shown in FIG. 8a, the retractable cartridge assembly 1600 fits directly onto the modified bracket 1610 with a tape hook 1610a. The tape hook 1610a also acts as a cover portion for covering the outer cutting blade 500 when the retractable cartridge assembly 1600 is not engaged. The modified bracket 1610 with a tape hook 1610a includes eyelets 1610b and 1610c, as shown in FIG. 8a, spaced substantially parallel to each other and perpendicular to the edges 300a and 300b of the tape 300. Spaced between the two eyelets 1610b and 1610c, and releasably mounted with both the eyelets 1610b and 1610c and the retractable cartridge 1650, is a spring 1660. The spring 1660 is metal. Alternatively, the spring 1660 is composed of one of or combinations of a number of materials including metals, elastomers, plastics and rubbers. The spring 1660 and eyelets 1610b and 1610c are constructed so that the slidable cartridge 1650 can move in the direction D7 and in the perpendicular direction D8, as shown in FIG. 8a. Alternatively, the spring 1660 and eyelets 1610b and 1610c can be constructed so that the slidable cartridge 1650 moves in other directions. As shown in FIG. 8a, the slidable cartridge 1650 is mounted substantially perpendicular to edges 300a and 300b of the tape 300. The spring 1660, biases the retractable cartridge 1650 in to the retracted position shown in FIG. 8a. In the retracted position of FIG. 8a, the outer cutting blade 500 is not exposed to prevent inadvertent contact with the user or other surfaces.

FIG. 8b is an end view of the retractable cartridge of FIG. 8a in an un-retracted position. To expose the outer cutting blade 500 and move the retractable cartridge 1650, the user pushes the top engagement portion 1670 in the direction towards the spring 1660 causing the spring 1660 to expand as shown in FIG. 8b. In the un-retracted position shown in FIG. 8b, retractable cartridge 1650 is moved so as to expose the outer cutting blade 500 below the cover portion 1610a to allow the cutting and scoring of a surface. In one embodiment of the present invention, depressing the top engagement portion 1670 once from the retracted position of FIG. 8a locks the spring 1660 in position of FIG. 8b in which the outer cutting blade 500 is exposed. To retract the retractable cartridge 1650 and disengage cutting blade 500, the user depresses the top engagement portion 1670 a second time, releasing the spring 1660 and disengaging the outer cutting blade 500 to return to the position of FIG. 8a. Alternatively, there can be no locking mechanism so that the user must continuously depress the top engagement portion 1670 and hold the spring to the position shown in FIG. 8b in order to keep the outer cutting blade 500 engaged the surface 101 to be cut or scored

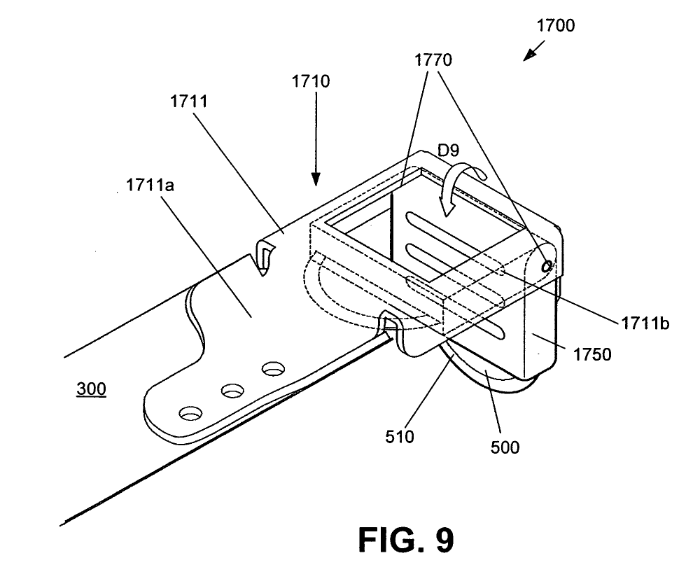

FIG. 9 is a perspective view of a pivotable and retractable cartridge. The modified bracket/tape hook 1710 in this embodiment to includes a body 1711 having a tape base 171 la with bridge arms 1711b extending from the tape base 1711a. As shown in FIG. 9, the bridge arms 1711b can be as wide as the retractable cartridge 1750. Alternatively, the bridge arms 1711b can be wider or more narrow than the retractable cartridge 400. The tape base 1711a is can be mounted to the tape 300 directly, as shown in FIG. 9, so as to add structural support for the bridge arms 1711b and pivotable retractable cartridge 1750.

As shown in FIG. 9, the bridge arms 1711b are connected to the pivotable retractable cartridge 1750 via hinge pins 1770. The pivotable retractable cartridge 1750 is attached to the bridge arms 1711b by the hinge pins 1770 so as to allow the pivotable retractable cartridge 1750 to rotate in the direction D9, as shown in FIG. 9. When the outer cutting blade 500 is engaged for cutting or scoring a surface (not shown), the pivotable retractable cartridge 1750 is rotated such that pivotable retractable cartridge 1750 is substantially perpendicular to the bridge arms 1711b. When the outer cutting blade 500 is not in use, the pivotable retractable cartridge 1750 is rotated along direction D9 so that the pivotable retractable cartridge 1750 is flush with the bridge arms 1711b and the blade is unexposed. When not in use, the outer cutting blade 500 can be retracted into the pivotable retractable cartridge 1750 via a spring (not shown).

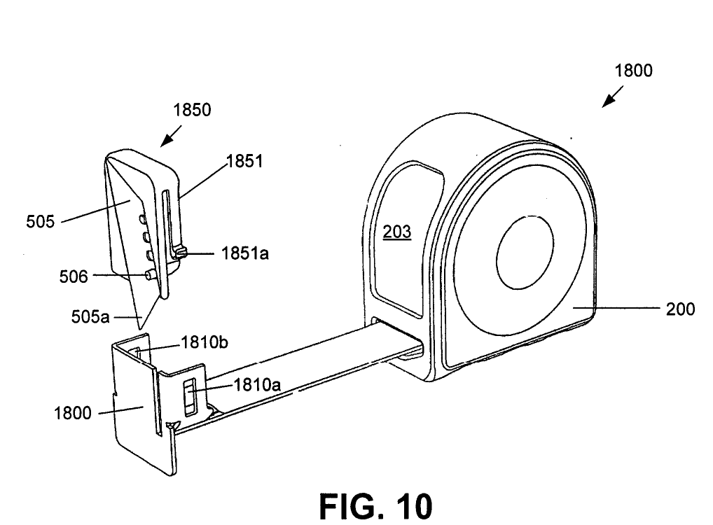

FIG. 10 is a perspective, partially exploded view of one embodiment of the tool of the present invention depicting a guide blade holder assembly. As shown in FIG. 10, an alternative embodiment of a tape hook 1800 includes a blade assembly 1850 with a guide blade holder 1851 that has side extensions 1851a, and a trapezoidal shaped cutting blade 505 that is mounted guide blade holder 1851. The guide blade holder 1851 can then be lowered into the tape hook 1800 whereby the side extensions 1851a releasably mate with the eyelets 1810a and 1810b holding the guide blade holder 1851 in the tape hook 1800. It should be noted that the trapezoidal shaped cutting blade 505 is preferably, but not necessarily held onto the guide blade holder 1851 by a guide blade peg 506 so that the exposed cutting edge 505a of the trapezoidal cutting blade 505 can be increased or decreased as desired by the user. As illustrated in FIG. 10, eyelets 1810a and 1810b only allow for vertical movement of the guide blade holder 1851, although as illustrated in previous embodiments (FIG. 8a) there are alternate embodiments of the present invention which allow for both vertical and horizontal movement of a retractable cartridge.

It will be apparent to those skilled in the art that various modifications and variations can be made in the precision measurement and cutting system for cutting a material of embodiments of the invention without departing from the spirit or scope of the invention. Thus, it is intended that embodiments of the invention cover the modifications and variations of this invention provided within the scope of the appended claims and their equivalents.

What is claimed is:

1. A precision measurement and cutting tool for cutting a material, the precision measurement and cutting tool comprising:
a measurement tape;
a housing for containing a measurement tape having an opening for the measurement tape on a first side; and
a first cartridge mounted at an end of the measurement tape and containing a retractable first cutting blade.

2. The precision measurement and cutting tool of claim 1, wherein the housing includes a finger guard extending from the housing in the direction of the first cartridge that protects the user from contact with the measurement tape.

3. The precision measurement and cutting tool of claim 1, wherein the housing includes a second cartridge containing a second retractable blade.

4. The precision measurement and cutting tool of claim 1, wherein the first retractable cartridge includes a bias member for biasing the cartridge to a position wherein the first cutting blade is covered and retracted.

5. The precision measurement and cutting tool of claim 1, wherein the precision measurement and cutting tool further comprises:
a blade holding assembly in communication with the measurement tape and exterior to the housing,
the blade holding assembly comprising a slidable container and a mounting members for replacements of the first cutting blade.

6. The precision measurement and cutting tool of claim 1, wherein the first cutting blade further comprises a cutting edge of greater than one inch in length.

7. The precision measurement and cutting tool of claim 1, wherein the first cartridge further comprises an engagement portion that allows for a user to expose the first cutting blade using one finger.

8. The precision measurement and cutting tool of claim 1 further comprising a guide for sliding against the surface of a material.

9. The precision measurement and cutting tool of claim 1, wherein the precision measurement and cutting tool further comprises a pivot pin mounted to the first cartridge, the pivot pin allowing for rotation of the first cutting blade around the pivot point.

10. The precision measurement and cutting tool of claim 3, the second cartridge further comprising a retractable cover for covering the second retractable blade.

11. The precision measurement and cutting tool of claim 1, further comprising a laser for projecting a reference line from the precision measurement and cutting tool mounted to the first cartridge.

12. The precision measurement and cutting tool of claim 1, further comprising a recess in the housing for receiving the first cartridge.

13. The precision measurement and cutting tool of claim 1, wherein the measurement tape has a top and a bottom side and the first cutting blade is mounted substantially perpendicular to the top side of the measurement tape.

14. The first cutting blade of claim 1, wherein the first cutting blade further comprises a trapezoidal shape.

15. The first cutting blade of claim 1, wherein the first cutting blade further comprises a disk shape having a perimeter and a blade along the perimeter.

16. A precision measurement and cutting tool for cutting a material, the precision measurement and cutting tool comprising:
a measurement tape having a top side and a bottom side and measuring indicia on the top side;
a housing for containing a measurement tape having a first side opposite a second side and a top side opposite a bottom side and having an opening for the measurement tape on a first side that is opposite a second side,
a first cartridge mounted at an end of the measurement tape and containing a retractable first cutting blade and including a bias member for biasing the cartridge to a position wherein the first cutting blade is covered and retracted;
an engagement portion on the first cartridge mechanically coupled to the retractable first cutting blade such that moving the engagement portion moves the retractable cutting blade to one of a retracted and an un-retracted position.

17. The precision measurement and cutting tool of claim 16, wherein the housing includes a finger guard extending from the housing in the direction of the first cartridge that protects the user from contact with the measurement tape.

18. The precision measurement and cutting tool of claim 16, wherein the housing includes a second cartridge containing a second retractable blade.

19. The precision measurement and cutting tool of claim 16, wherein the precision measurement and cutting tool further comprises:
a blade holding assembly in communication with the measurement tape and exterior to the housing,
the blade holding assembly comprising a slidable container and a mounting members for replacements of the first cutting blade.

20. The precision measurement and cutting tool of claim 16, wherein the first cutting blade further comprises a cutting edge of greater than one inch in length.

21. The precision measurement and cutting tool of claim 16, wherein the engagement portion is sized and positioned such that moving the engagement portion is done with one finger.

22. The precision measurement and cutting tool of claim 16, wherein the precision measurement and cutting tool further comprises a guide on the second side of the housing for sliding the housing against the surface of a material.

23. The precision measurement and cutting tool of claim 16, wherein the precision measurement and cutting tool further comprises a pivot pin mounted to the first cartridge, the pivot pin allowing for rotation of the first cutting blade around the pivot point.

24. The precision measurement and cutting tool of claim 18, the second cartridge further comprising a retractable cover for covering the second retractable blade.

25. The precision measurement and cutting tool of claim 16, further comprising a laser for projecting a reference line from the precision measurement and cutting tool mounted to the first cartridge.

26. The precision measurement and cutting tool of claim 16, further comprising a recess in the housing for receiving the first cartridge.

27. The precision measurement and cutting tool of claim 16, wherein the first cutting blade is mounted substantially perpendicular to the top side of the measurement tape.

28. The first cutting blade of claim 16, wherein the first cutting blade further comprises a trapezoidal shape.

29. A precision measurement and cutting tool for cutting a material, the precision measurement and cutting tool comprising:
a measurement tape having a top side and a bottom side and measuring indicia on the top side;
a tape hook at a first end of the measuring tape;
a housing for containing a measurement tape having a first side opposite a second side and a top side opposite a bottom side and having an opening for the second end of the measurement tape on a first side that is opposite a second side,
a first cartridge mounted at an end of the measurement tape and containing a retractable first cutting blade and including a bias member for biasing the cartridge to a position wherein the first cutting blade is covered and retracted,
the first cartridge comprising a bracket;
an engagement portion on the first cartridge mechanically coupled to the retractable first cutting blade such that moving the engagement portion moves the retractable cutting blade to one of a retracted and an un-retracted position.

30. The precision measurement and cutting tool of claim 29, wherein the precision measurement and cutting tool further comprises a first cutting blade storage area in communication with the exterior of the housing.

31. The precision measurement and cutting tool of claim 29, wherein the precision measurement and cutting tool further comprises a guide on the second side of the housing for sliding the housing against the surface of a material.

32. The precision measurement and cutting tool of claim 29, wherein the precision measurement and cutting tool further comprises a pivot pin mounted to the first cartridge, the pivot pin allowing for rotation of the first cutting blade around the pivot point.
